(19) United States
(12) Patent Application Publication
(10) Pub. No.: US 2008/0312989 A1
(43) Pub. Date: Dec. 18, 2008

(54) EVALUATION SYSTEM, EVALUATION EQUIPMENT, AND COMPUTER PROGRAM

(76) Inventor: Koji OKADA, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/836,916

(22) Filed: Aug. 10, 2007

(30) Foreign Application Priority Data
Aug. 11, 2006 (JP) 2006-219812

(51) Int. Cl. G06F 9/44

(52) U.S. Cl. 705/7

(57) ABSTRACT

An evaluation system, an evaluation method, and a computer program that specify an effect inhibition factor are provided. The evaluation system specifies the effect inhibition factor when an introduction effect of a predetermined system such as a support system cannot be acquired. Further, the evaluation system notifies a user of a countermeasure according to the specified effect inhibition factor. Specifically, the evaluation system ascertains operation status of the support system and a user comprehension degree with respect to an operation method of the support system, thereby specifying a factor inhibiting the introduction effect (effect inhibition factor) and a countermeasure according to the effect inhibition factor.

### BACKGROUND OF THE INVENTION

The present invention relates to an evaluation system, and more particularly, to an evaluation technique which evaluates a support system that supports improvement/reformation of a business process.

Known support systems that support the improvement/reformation of the business process include enterprise resource planning (ERP) systems, product data management (PDM) systems, project management (PM) systems, knowledge management (KM) systems, and the like. For example, “SAP Revolution” (ERP Workshop, January, 1997, first edition, ISBN 4-8207-1248-9) includes the following description on page 12, regarding an ERP system which is one of such supporting systems.

“In ERP, functions of businesses over entire corporate activities are provided as a ‘best business practice’. The best business practice is a process that is made common from processes employed in companies with good performance around the world, and is a standard for a global business process used worldwide. Companies introducing the ERP can carry on their own business using a ‘business process model’ provided according to ‘best business practice’. By switching business processes of the company to best business practice as described above, business process re-engineering (BPR) is realized. In view of the above, ERP is a system that supports re-engineering.”

Note that “business process re-engineering” in this case refers to improvement/reformation of the business process, and “best business practice” in this case refers to a business process that is a target of the business process improvement/reformation by ERP.

However, users are unable to know whether an already-existing system has been improved/reformed by merely introducing a support system in the already-existing system. Thus, a need arises s for a system which quantitatively measures an effect of introducing the support system.

For example, Japanese Patent Laid-open Publication No. 2005-148856 discloses a method of measuring an effect of introducing an information technology (IT) system into an already-existing system. Specifically, an IT investment effect measurement system acquires from the introduced IT system data indicating profit status of a company, data indicating business process progression status, and data indicating operation status of the IT system. Further, the IT investment effect measurement system acquires an IT system investment effect by carrying out a predetermined analysis based on the acquired pieces of data.

However, by merely quantitatively measuring the system introduction effect of the support system or the like, when the introduction effect cannot be acquired, it is impossible to specify a cause thereof (hereinafter, referred to as effect inhibition factor). Further, it is beneficial if an appropriate countermeasure in the case where the introduction effect cannot be acquired can be made known.

### SUMMARY OF THE INVENTION

It is a primary object of the present invention to provide a technique that specifies an effect inhibition factor in a case where a predetermined system introduction effect cannot be obtained. Further, a secondary object of the present invention is to provide a technique that notifies users of a countermeasure according to the specified effect inhibition factor.

To achieve the above-mentioned objects, in the present invention, an evaluation system executes the following processing. That is, the evaluation system ascertains operation status of a support system already introduced. In addition, the evaluation system ascertains user comprehension degree with respect to an operation method of the support system. Based on those pieces of data, the evaluation system specifies a factor that inhibits the introduction effect (effect inhibition factor). Further, the evaluation system specifies a countermeasure according to the specified effect inhibition factor.

Specifically, there is provided an evaluation system which receives an instruction from at least one user and carries out an evaluation regarding a support system that supports a task of the at-least-one user by executing processing according to the instruction, including: an analysis table in which is recorded, for each operation evaluation item, a rule for calculating an operation evaluation index based on the instruction from the at least one user; a question table in which is recorded, for each comprehension degree evaluation item, a question group which is used for calculating a comprehension degree evaluation index based on a comprehension degree of the at least one user regarding the support system; an evaluation table in which is recorded, for each support system evaluation item, the evaluation regarding the support system in association with the operation evaluation index and the comprehension degree evaluation index; an instruction history recording unit which acquires and records the instruction from the at-least-one user received by the support system; an operation evaluation index calculation unit which calculates the operation evaluation index for each of the operation evaluation items based on the instruction recorded by the instruction history recording unit and the analysis table; a presenting unit which presents a question group among question groups recorded in the question table; a comprehension degree evaluation index calculation unit which calculates the comprehension degree evaluation index for each of the comprehension degree evaluation items after receiving answers to the question group presented by the presenting unit from the at-least-one user; and an evaluation unit which carries out the evaluation regarding the support system for each of the support system evaluation items based on the operation evaluation index calculated by the operation evaluation index calculation unit on the comprehension degree evaluation index calculated by the comprehension degree evaluation index calculation unit, and on the evaluation table, and outputs the evaluation result.

Note that in the following, a detailed description is given of an embodiment of the present invention. However, it is assumed that configurations exemplified in the embodiment have a degree of freedom in possible combinations thereof, and any combination constitutes the present invention. Specifically, an embodiment obtained by appropriately removing a partial configuration from the embodiment described below may possibly be regarded as another embodiment of the present invention. Further, any of the configurations specifically described below is no more than a subordinate concept of superordinate concepts assumed to have the same functions.

According to the evaluation system of the present invention, the effect inhibition factor can be specified when a predetermined system introduction effect cannot be acquired. In addition, according to the evaluation system of the present invention, an appropriate countermeasure can be notified to the user.

### BRIEF DESCRIPTION OF THE DRAWINGS

In the accompanying drawings:

FIG. 1 is a block diagram showing an example of a configuration of an information processing system according to an embodiment of the present invention;

FIG. 2 is a diagram schematically showing a method which specifies an effect inhibition factor;

FIG. 3 is a diagram showing content of a long-term memory that stores various programs and the like for specifying the effect inhibition factor;

FIG. 4A is a diagram showing content of an operation status ascertaining program;

FIG. 4B is a diagram showing content of a user comprehension degree ascertaining program;

FIG. 5 is a diagram showing content of a database storage unit that stores various databases;

FIG. 6 is a diagram schematically showing a data structure of an operation log table;

FIG. 7 is a diagram schematically showing a data structure of an operation log analysis rule table;

FIG. 8 is a diagram schematically showing a data structure of an operation status ascertaining result table;

FIG. 9 is a diagram schematically showing a data structure of a user comprehension degree ascertaining question table;

FIG. 10A is a diagram schematically showing a data structure of a user response result table;

FIG. 10B is a diagram schematically showing a data structure of a user comprehension degree ascertaining result table;

FIG. 11 is a diagram schematically showing a data structure of an effect inhibition factor/countermeasure table;

FIG. 12 is a functional configuration diagram of the information processing system according to the embodiment of the present invention;

FIG. 13 is a flowchart of operation status ascertaining processing executed in the information processing system according to the embodiment of the present invention;

FIG. 14 is a flowchart of user comprehension degree ascertaining processing executed in the information processing system according to the embodiment of the present invention;

FIG. 15 is a flowchart of effect inhibition factor/countermeasure specification processing executed in the information processing system according to the embodiment of the present invention; and

FIG. 16 is a diagram showing a layout example of an effect inhibition factor specification result screen displayed on a display unit.

### DESCRIPTION OF THE PREFERRED EMBODIMENTS

Hereinafter, a preferred embodiment of the present invention will be described with reference to the drawings.

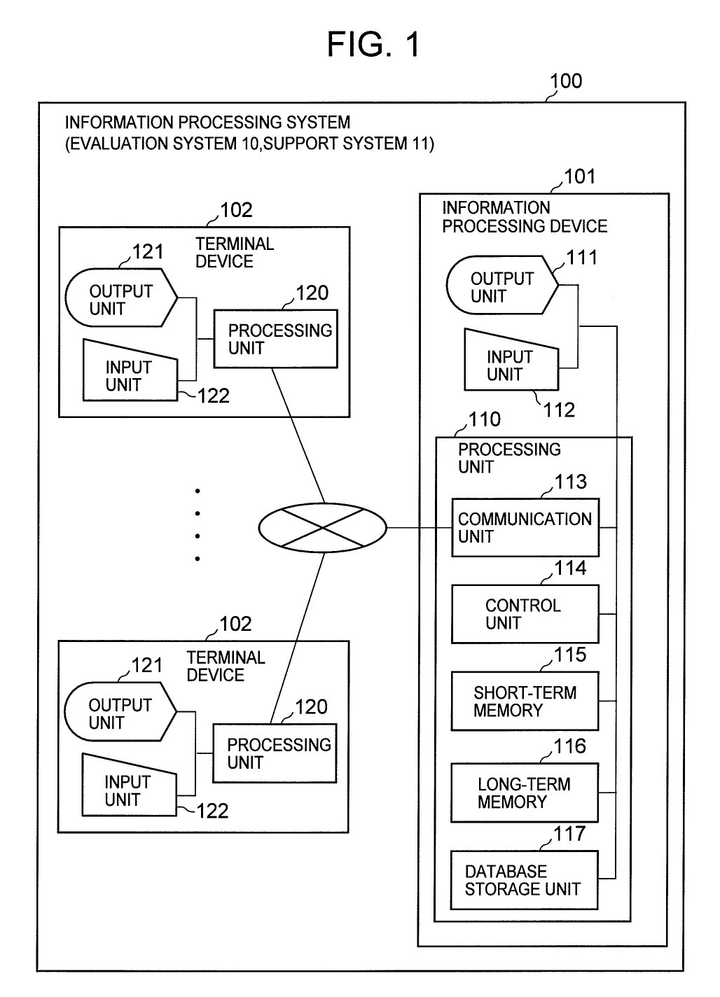

An evaluation system 10 that is applied to the embodiment of the present invention functions as an evaluation system by being applied to an information processing system 100 configured as shown in FIG. 1 together with a support system 11.

The information processing system 100 includes an information processing device 101 and a plurality of terminal devices 102. Note that the information processing device 101 may be configured by a plurality of information processing devices 101. Further, the plurality of terminal devices 102 may be configured as a single terminal device 102.

The information processing device 101 and the plurality of terminal devices 102 are connected to one another via a network 103 (e.g., local area network (LAN) or wide area network (WAN)). Further, a protocol used for communication between each of the devices may be, for example, a transmission control protocol/internet protocol (TCP/IP).

The information processing system 100 configured as described above operates as the support system 11 which prevents delay of a project (task).

Hereinafter, a description will be given of an overview of the information processing system 100 when the information processing system 100 operates as the support system 11.

First, the support system 11 identifies a user of the support system 11 through a usual operation for log-in authentication. Here, the user is classified as, for example, a user who manages a project (manager) or a user who processes the project (person in charge of a task).

The manager newly registers/corrects/deletes project data such as a project name and project contents. In addition, the manager adds a task item to the project and newly registers/corrects/deletes task data such as a task name, a person in charge of the task, a scheduled task start date, and a scheduled task completion date.

On the other hand, the person in charge of the task displays a list of the task items or registers task progression status data (e.g., task start date and task completion date).

The support system 11 compares the task data registered by the manager and the task progression status data registered by the person in charge of the task, to thereby specify the task item that is delayed. In addition, the support system 11 notifies the user of the task item in delay.

As described above, by the information processing system 100 operating as the support system 11, the user can readily grasp the task progression status of the project to thereby take countermeasures therefor.

However, there are cases where the delay of the project cannot be prevented even when the information processing system 100 is operated as the support system 11, as described above. In other words, there are cases where the effect of introducing the support system 11 cannot be acquired. The evaluation system 10 applied to the information processing system 100 is a system that specifies a cause that inhibits prevention of the delay of the project (effect inhibition factor) in such cases.

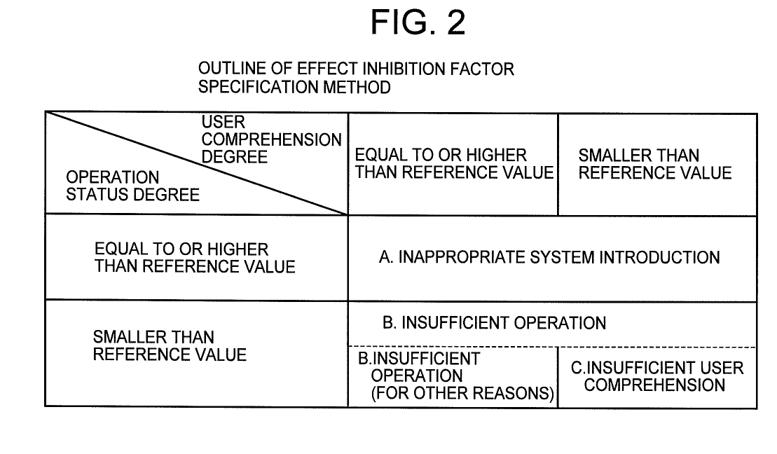

Hereinafter, by referring to FIG. 2, an outline of a method by which the evaluation system 10 specifies an effect inhibition factor will be described.

Cause of the support system 11 being unable to prevent the delay of the project include a case where introduction of the support system 11 itself has been inappropriate, and a case where the introduction of the support system 11 has been appropriate but the operation status has been inappropriate.

If the delay of the project cannot be prevented even when the operation status is appropriate, it is judged that the introduction of the support system 11 itself has been inappropriate (A. inappropriate system introduction). Further, when the operation status is inappropriate, it is judged that the user of the support system 11 is misusing the operation method (B. insufficient operation).

Thus, the evaluation system 10 ascertains operation status degree indicating degree of the operation status of the support system 11. Then, the evaluation system 10 judges whether the operation status degree is equal to or higher than a reference value, whereby judgment can be made on which of: A. inappropriate system introduction, and B. insufficient operation, the cause is attributable to. Processing for ascertaining the operation status degree ((1) operation status ascertaining processing) will be described later.

Next, the cause of the B. insufficient operation may be where the user does not understand the operation method. When the user does not understand the operation method (C. insufficient user comprehension), it is only necessary to teach the operation method to the user. When the operation status is inappropriate even when the user understands the operation method (B. insufficient operation (for other reasons)), other countermeasures need to be discussed.

Thus, the evaluation system 10 ascertains the comprehension degree of the user with respect to the operation method. Then, the evaluation system 10 judges whether the comprehension degree is equal to or higher than the reference value, whereby judgment can be made on which of: C. insufficient user comprehension, and B. insufficient operation (for other reasons), the cause is attributable to. Processing for ascertaining the user comprehension degree ((2) user comprehension degree ascertaining processing) will be described later.

The evaluation system 10 specifies a cause that inhibits prevention of the delay of the project (effect inhibition factor) based on the operation status degree ascertained in the (1) operation status ascertaining processing, and the user comprehension degree ascertained in the (2) user comprehension degree ascertaining processing, described above. Processing of specifying the effect inhibition factor ((3) effect inhibition factor/countermeasure specification processing) will be described later.

Referring again to FIG. 1, the information processing device 101 includes a processing unit 110, an output unit 111, and an input unit 112. The information processing device 101 is a device to which input of instructions and the like is made by the manager managing the project. In addition, the information processing device 101 executes the respective types of processing described above ((1) operation status ascertaining processing, (2) user comprehension degree ascertaining processing, and (3) effect inhibition factor/countermeasure specification processing) based on a request from the terminal device 102 connected via the network 103. Further, the information processing device 101 notifies the user of the effect inhibition factor acquired in the (3) effect inhibition factor/countermeasure specification processing.

The processing unit 110 includes a communication unit 113, a control unit 114, a short-term memory unit 115, a long-term memory unit 116, and a database storage unit 117. Each of the units included in the processing unit 110 will be described later.

The output unit 111 is composed of an output device such as a liquid crystal display (LCD). The user can ascertain content of data supplied from the processing unit 110 by looking at images or character strings displayed on the LCD. The LCD in this case is a display element of a dot matrix type, and displays arbitrary characters, symbols, numerals, and figures.

The input unit 112 is composed of input devices such as a keyboard and a mouse. The input unit 112 receives data input by the user using those input devices, and supplies the input data to the processing unit 110. For example, the input unit 112 receives data for requesting starting of the (1) operation status ascertaining processing, the (2) user comprehension degree ascertaining processing, or the (3) effect inhibition factor/countermeasure specification processing described above, and supplies the data to the processing unit 110.

Next, a description will be given of each of the units included in the processing unit 110.

The control unit 114 is composed of a computer processing device such as a central processing unit (CPU), and performs overall control of the information processing device 101. In addition, the control unit 114 reads a program stored in the long-term memory unit 116 and executes predetermined processing based on the program. For example, the control unit 114 carries out processing of referring to data stored in the database storage unit 117. Further, the control unit 114 starts the (1) operation status ascertaining processing, the (2) user comprehension degree ascertaining processing, the (3) effect inhibition factor/countermeasure specification processing, and the like, based on the data supplied from the input unit 112. Processing executed by the control unit 114 will be described later in detail.

The short-term memory unit 115 is composed of a volatile memory such as a random access memory (RAM). The short-term memory unit 115 temporarily stores a program read out by the control unit 114 to execute predetermined processing (e.g., effect inhibition factor/countermeasure specification processing). In addition, the short-term memory unit 115 temporarily stores data necessary for the control unit 114 to execute the read program.

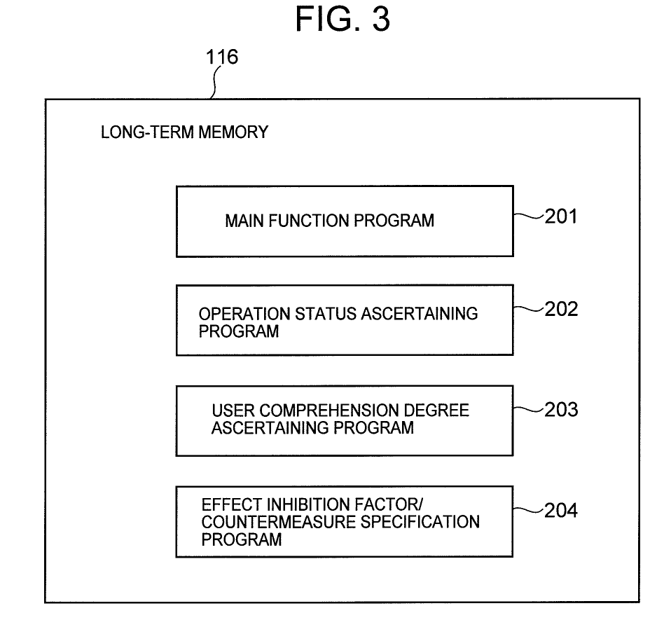

The long-term memory unit 116 is composed of a non-volatile memory such as a read-only memory (ROM) or a hard disk. The long-term memory unit 116 stores in advance a program and the like, necessary for the control unit 114 to execute the predetermined processing. For example, as shown in FIG. 3, the long-term memory unit 116 stores a main function program 201 that causes the information processing system 100 to operate as the support system 11, which aims to prevent a delay of a project (task). In addition, the long-term memory unit 116 stores an operation status ascertaining program 202 used for ascertaining operation status of the support system 11 incorporated in the information processing system 100. Further, the long-term memory unit 116 stores user comprehension degree ascertaining program 203 used for ascertaining the user comprehension degree with respect to the operation method of the support system 11. Still further, the long-term memory unit 116 stores an effect inhibition factor/countermeasure specification program 204 used for specifying a factor that inhibits the introduction effect of the support system 11, and specifying a countermeasure according to the specified factor.

The control unit 114 reads each of the programs from the long-term memory unit 116 if necessary, develops the program in the short-term memory unit 115, and executes the predetermined processing based on the program.

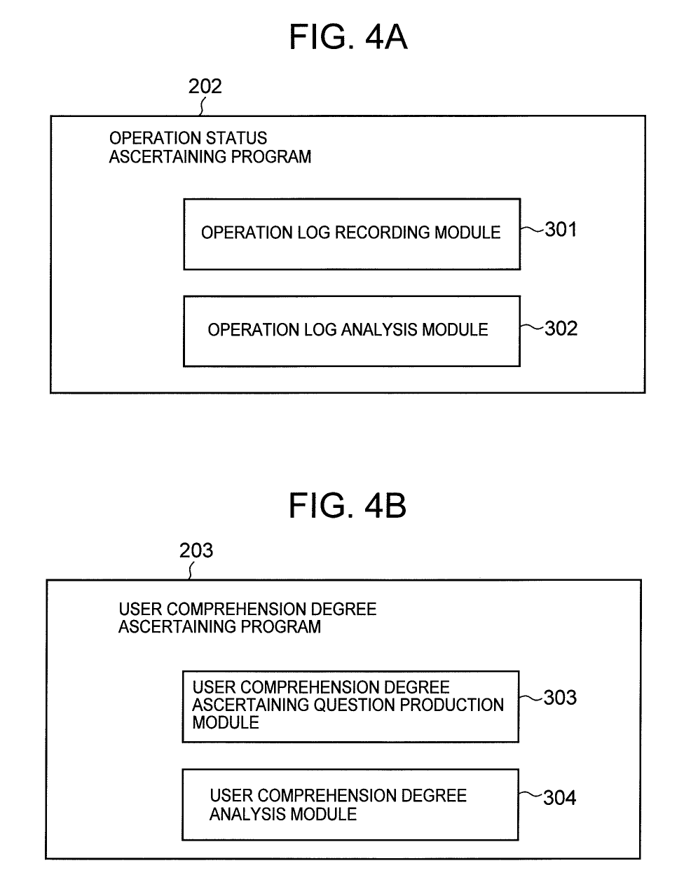

Further, as shown in FIG. 4A, the operation status ascertaining program 202 includes an operation log storage module 301 that stores logs of operation made by the user (hereinafter, referred to as operation log) with respect to the support system 11. In addition, the operation status ascertaining program 202 includes an operation log analysis module 302 that ascertains the operation status of the support system 11 from the operation logs.

Further, as shown in FIG. 4B, the user comprehension degree ascertaining program 203 includes a user comprehension degree ascertaining question production module 303 that produces questions for ascertaining the user comprehension degree with respect to the operation method of the support system 11. In addition, the user comprehension degree ascertaining program 203 includes a user comprehension degree analysis module 304 that stores and analyzes answers of the user with respect to the produced questions.

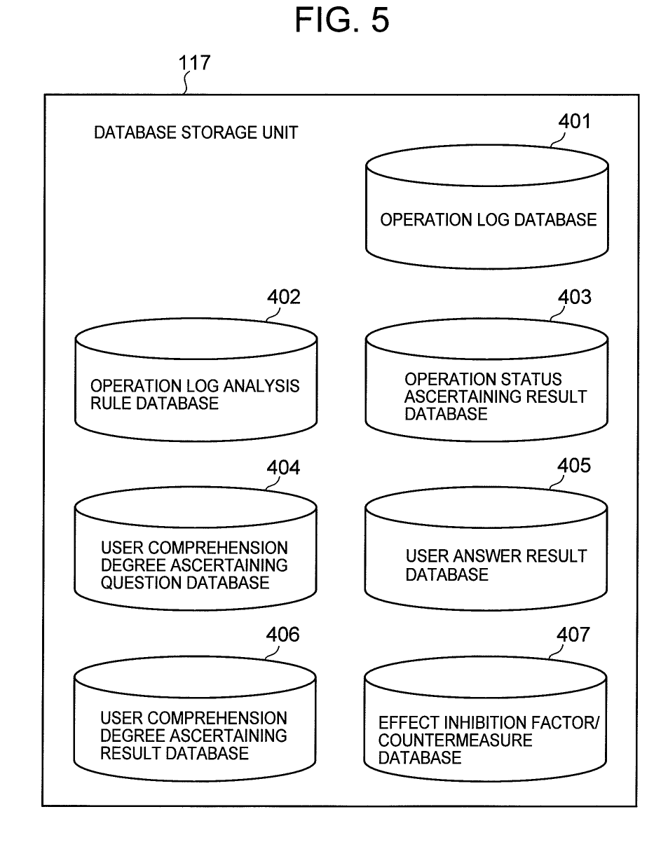

As shown in FIG. 5, the database storage unit 117 stores an operation log database 401, an operation log analysis rule database 402, an operation status ascertaining result database 403, a user comprehension degree ascertaining question database 404, a user answer result database 405, a user comprehension degree ascertaining result database 406, and an effect inhibition factor/countermeasure database 407.

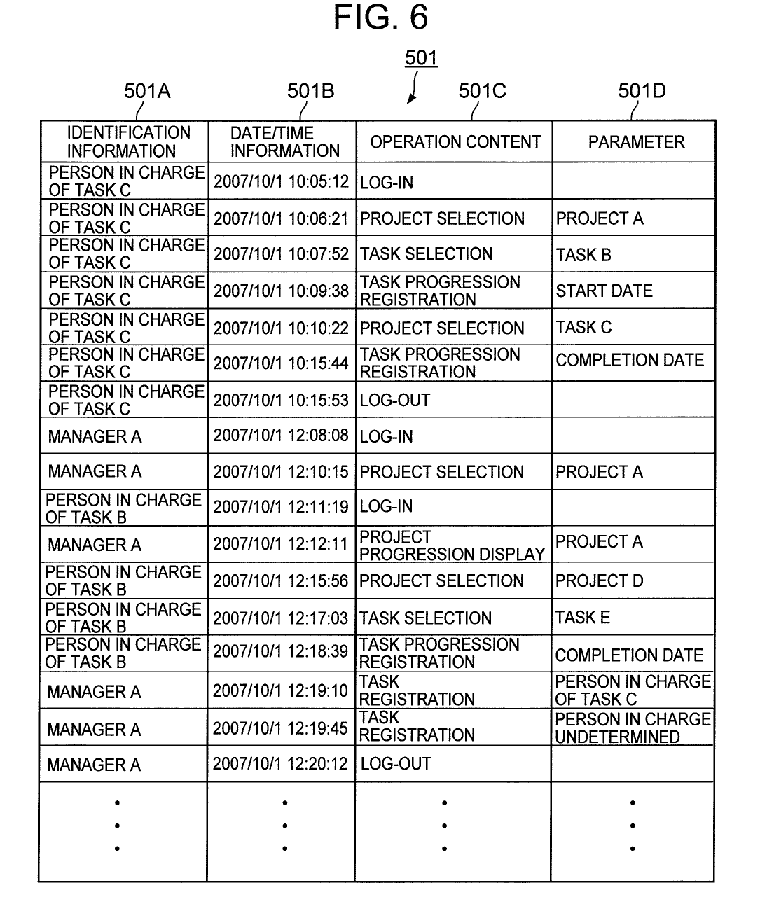

The operation log database 401 stores an operation log table 501 as shown in FIG. 6. Identification information 501A with which a user who has accessed the information processing device 101 is identified, date/time information 501B indicating an operation date/time, an operation contents 501C, parameters 501D to be operation targets, and the like are stored in the operation log table 501.

The identification information 501A in this case is information that varies for each user (manager and persons in charge of the task), and may be a general account assigned as a privilege for using resources in a computer or in a network, for example. The identification information 501A is transmitted from the information processing device 101 or the terminal device 102 every time an operation is made by the user, and is stored in the operation log table 501. Further, when the identification information 501A is stored in the operation log table 501, the date/time information 501B indicating an operation date/time of the user, the operation content 501C, and the parameter 501D are also stored in association therewith.

The date/time information 501B is information indicating a date/time on which the user has made an operation to the information processing system 100. For example, as shown in FIG. 6, the date/time information 501B is described in a format of “year/month/day hour/minute/second”.

The operation content 501C is information indicating content of an operation made by the user with respect to the information processing system 100. For example, the operation content 501C contains information such as “log-in” regarding the user logging-in to the information processing device 101, “project selection” regarding the user selecting a project as an editing target, “task progression registration” regarding registration of a start and end of a task for which the person in charge of the task is responsible, and “task registration” regarding the manager registering a start schedule and an end schedule of the task.

The parameter 501D is information corresponding to the operation content 501C. For example, when the operation content 501C is “project selection”, the parameter 501D contains information such as “project A” which is a selected project name, identification information of the person in charge of the task who has been allocated to the task registered in the “task registration”, or the like. Note that information such as “person in charge undetermined” and the like is stored as the parameter 501D in a case where a person in charge of a task registered in the “task registration” has not been allocated to the task.

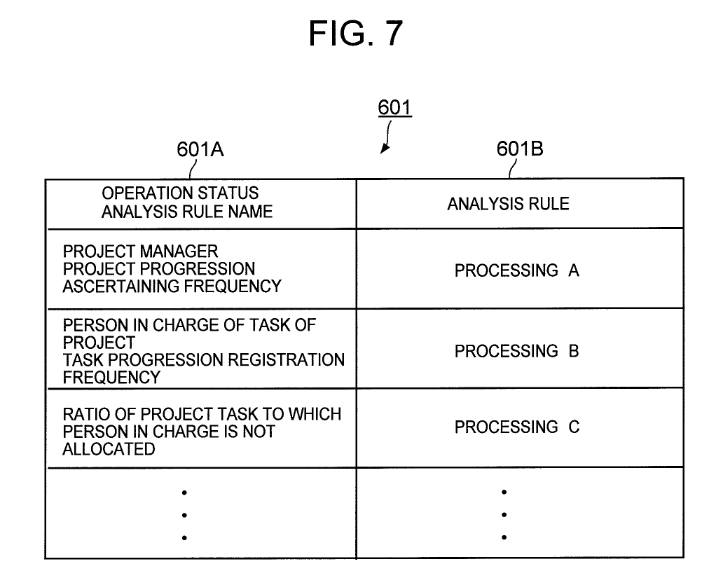

The operation log analysis rule database 402 stores an operation log analysis rule table 601 as shown in FIG. 7, and the like. The operation log analysis rule table 601 stores an operation status analysis rule name 601A indicating a name of each type of rule for analyzing the operation logs, an analysis rule 601B indicating a processing procedure for analyzing the operation logs by the information processing system 100, and the like.

The operation status analysis rule name 601A and the analysis rule 601B are stored in advance in the operation log analysis rule table 601.

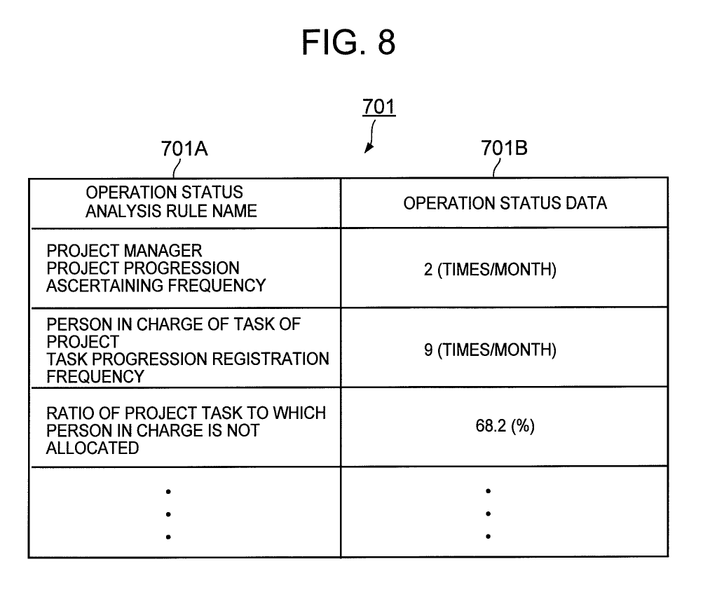

The operation status ascertaining result database 403 stores an operation status ascertaining result table 701 as shown in FIG. 8, and the like. The operation status ascertaining result table 701 stores an operation status analysis rule name 701A indicating a name of each type of rule for analyzing the operation logs, operation status data 701B indicating a result of processing performed by the information processing system 100 according to the analysis rule 601B, and the like.

The operation status analysis rule name 701A and the operation status data 701B are stored in the operation status ascertaining result table 701 every time the information processing system 100 performs processing according to the analysis rule 601B.

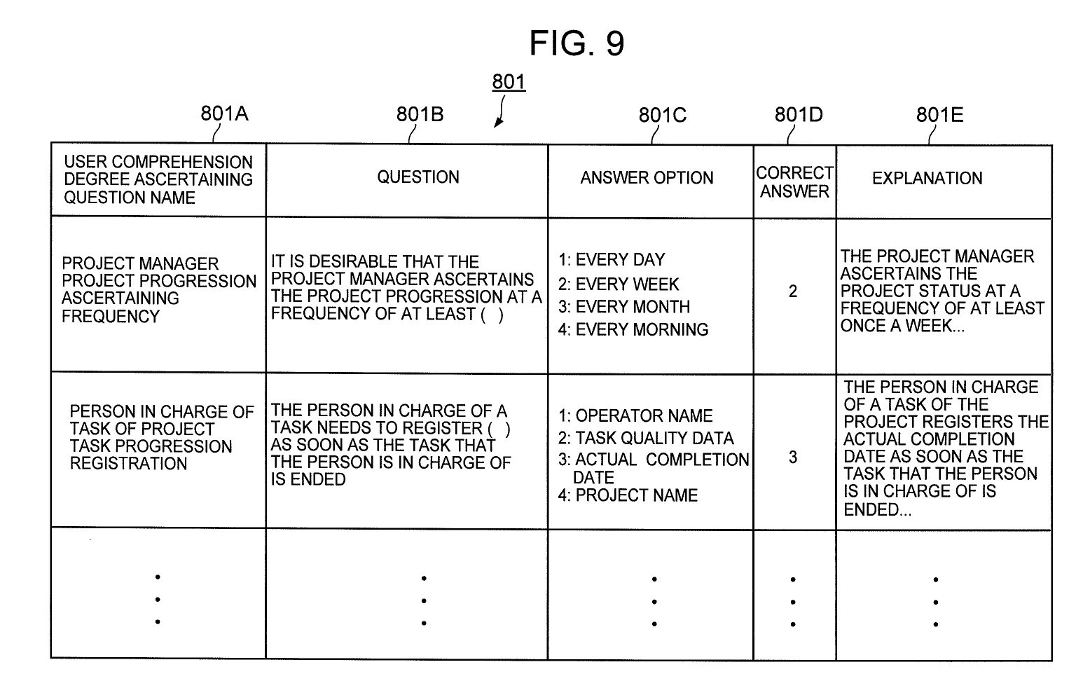

The user comprehension degree ascertaining question database 404 stores a user comprehension degree ascertaining question table 801 as shown in FIG. 9, and the like. The user comprehension degree ascertaining question table 801 stores user comprehension degree ascertaining question names 801A indicating names of a questions for ascertaining the user degree of comprehension with respect to the operation method of the support system 11. The user comprehension degree ascertaining question names 801A in this case contains information for distinguishing between questions for the project manager and questions for persons in charge of the task. Further, the user comprehension degree ascertaining question table 801 stores questions 801B indicating contents of the questions for ascertaining the user comprehension degree with respect to the operation method of the support system 11. Further, the user comprehension degree ascertaining question table 801 stores answer options 801C indicating options for prompting the user to select an answer to the question 801B, correct answers 801D indicating correct answers to the question 801B, explanations 801E indicating explanations with respect to the question 801B, and the like.

Each of the pieces of data 801A to 801E is stored in advance in the user comprehension degree ascertaining question table 801.

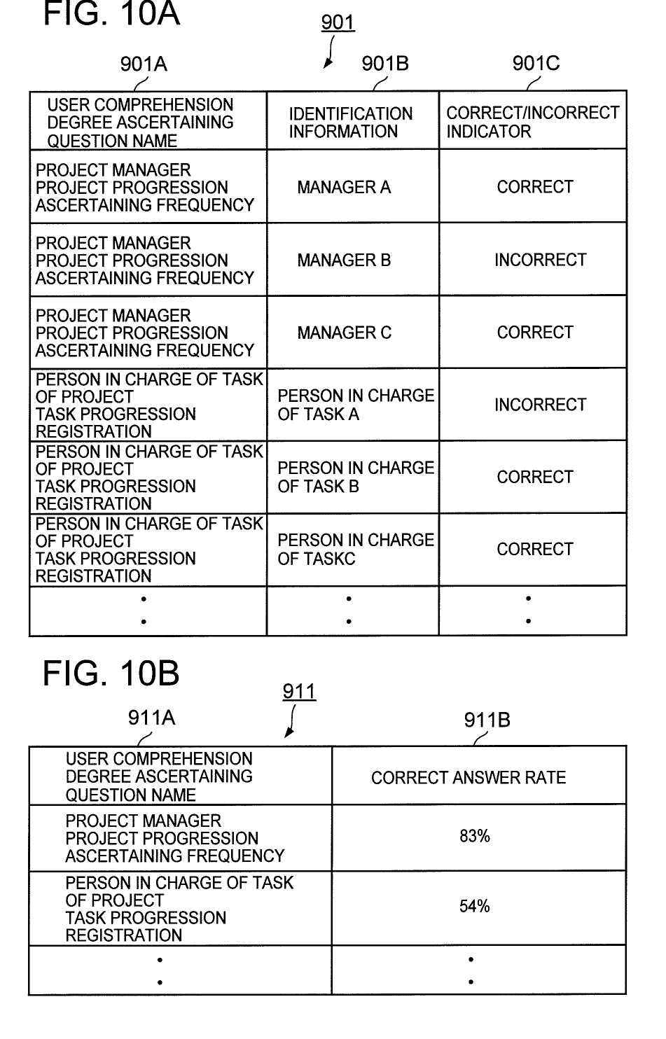

The user answer result database 405 stores a user answer result table 901 as shown in FIG. 10A, and the like. The user answer result table 901 stores a user comprehension degree ascertaining question names 901A indicating names of the questions for ascertaining the user comprehension degree with respect to the operation method of the support system 11. Further, the user answer result table 901 stores identification information 901B used for identifying an answerer. In addition, the user answer result table 901 stores correct/incorrect indicators 901C indicating that the answers to the question 801B answered by the user are correct or incorrect, and the like.

The user comprehension degree ascertaining question name 901A, the identification information 901B, and the correct/incorrect indicator 901C are stored in the user answer result table 901 every time the user gives an answer to the question 801B.

The user comprehension degree ascertaining result database 406 stores a user comprehension degree ascertaining result table 911 as shown in FIG. 10B, and the like. The user comprehension degree ascertaining result table 911 stores user comprehension degree ascertaining question names 911A indicating names of the questions for ascertaining the user comprehension degree with respect to the operation method of the support system 11. Further, the user comprehension degree ascertaining result table 911 stores correct answer rate 911B indicating correct answer rate of all the answerers for each question 801B, and the like.

The user comprehension degree ascertaining question 911A and the correct answer rate 911B are stored in the user comprehension degree ascertaining result table 911 every time an answer to the question 801B is acquired from the answerer.

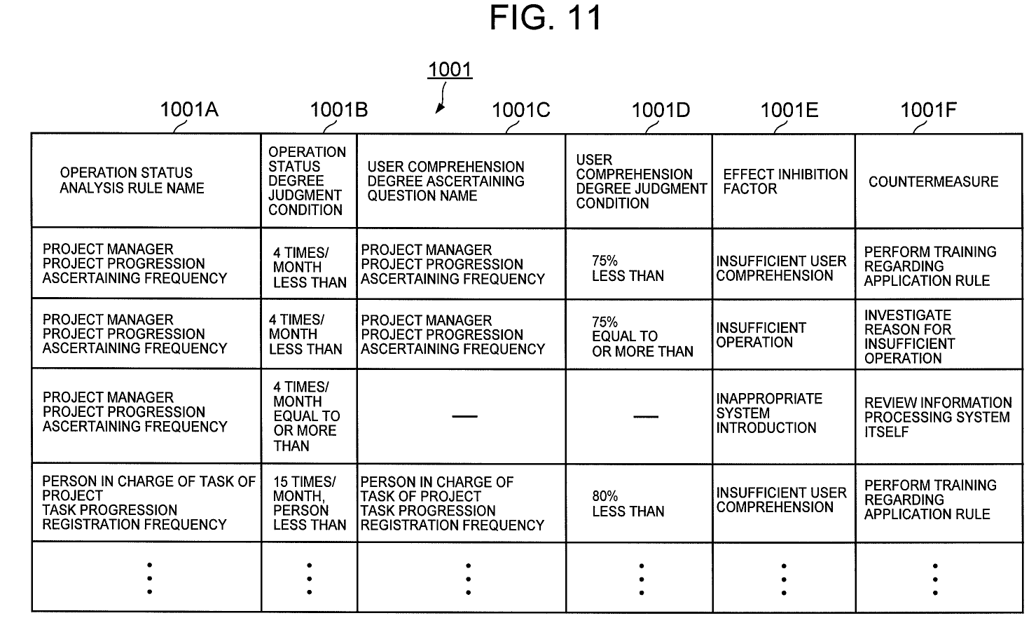

The effect inhibition factor/countermeasure database 407 stores an effect inhibition factor/countermeasure table 1001 as shown in FIG. 11, and the like. In the effect inhibition factor/countermeasure table 1001, rule names corresponding to the operation status analysis rule names 601A and 701A described above are stored as operation status analysis rule names 1001A. Further, the effect inhibition factor/countermeasure table 1001 stores operation status degree judgment conditions 1101B indicating information to be conditions for judging whether the introduction of the support system 11 has been appropriate. Further, in the effect inhibition factor/countermeasure table 1001, the question names corresponding to the user comprehension degree ascertaining question names 801A, 901A, and 911A described above are stored as user comprehension degree ascertaining question names 100C. In addition, the effect inhibition factor/countermeasure table 1001 stores user comprehension degree judgment conditions 1001D indicating information to be conditions for judging whether the user is sufficiently understanding the operation method of the support system 11. Further, the effect inhibition factor/countermeasuretable 1001 stores an effect inhibition factors 1001E indicating factors inhibiting the introduction effect of the support system 11, countermeasures 1010F indicating countermeasures with respect to the inhibition factors, and the like.

Each of the pieces of data 100lA to 1001F is stored in advance in the effect inhibition factor/countermeasure table 1001.

The information processing system 100 specifies a factor inhibiting the introduction effect of the support system 11 (effect inhibition factor) by referring to the effect inhibition factor/countermeasure table 1001.

Referring again to FIG. 1, the communication unit 113 is composed of, for example, a network interface card (NIC), and includes an interface for connecting with the network 103. The communication unit 113 performs communication with the network 103 based on a TCP/IP protocol. The communication unit 113 may include, for example, a modem device or an infrared ray communication device.

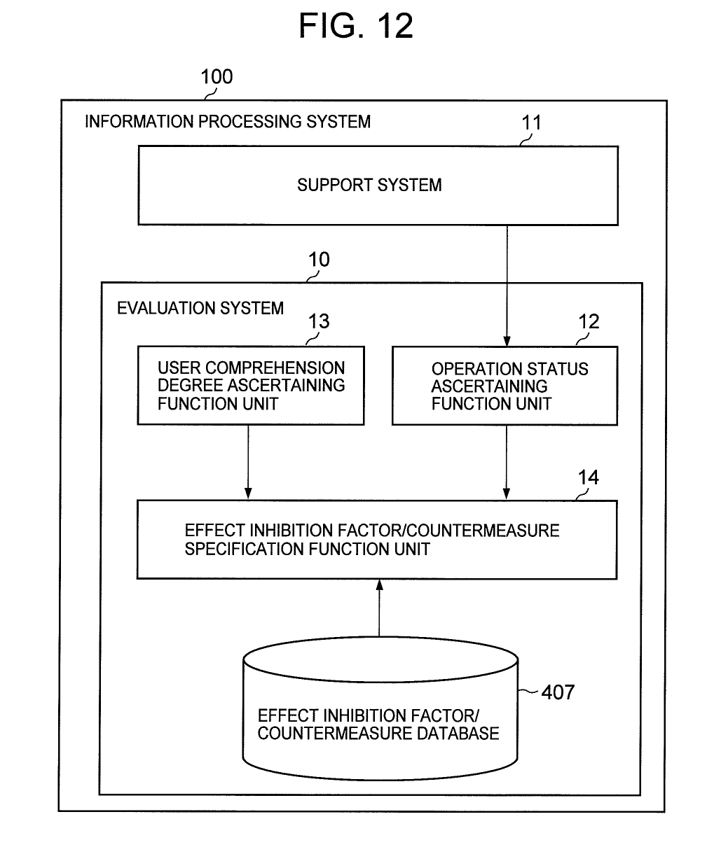

With the configuration as described above, the information processing device 101 realizes functional components 10 to 14 shown in FIG. 12. Specifically, the support system 11 causes the information processing system 100 to operate with an aim at preventing delay of a project (task). The evaluation system 10 causes the information processing system 100 to operate with an aim at specifying an effect inhibition factor/countermeasure. The evaluation system 10 includes an operation status ascertaining function unit 12, a user comprehension degree ascertaining function unit 13, an effect inhibition factor/countermeasure specification function unit 14, and an effect inhibition factor/countermeasure database 407. The operation status ascertaining function unit 12 acquires logs of user operation with respect to the support system 11. The operation status ascertaining function unit 12 analyzes the acquired logs and supplies the analysis result to the effect inhibition factor/countermeasure specification function unit 14. Further, the user comprehension degree ascertaining function unit 13 ascertains the user comprehension degree with respect to the operation method of the support system 11. The user comprehension degree ascertaining function unit 13 produces questions for measuring the user comprehension degree, and acquires answers to the questions. The user comprehension degree ascertaining function unit 13 carries out statistic processing on the acquired answers, and supplies the result of the statistic processing to the effect inhibition factor/countermeasure specification function unit 14. The effect inhibition factor/countermeasure specification function unit 14 specifies an effect inhibition factor and a countermeasure by referring to the effect inhibition factor/countermeasure database 407 described above based on the data supplied from the operation status ascertaining function unit 12 and the data supplied from the user comprehension degree ascertaining function unit 13.

As described above, the information processing device 101 can be configured by using a generally available computer or the like.

Next, a description will be given of the terminal device 102 connected to the network 103 shown in FIG. 1. Similar to the information processing device 101, the terminal device 102 includes a processing unit 120, an output unit 121, and an input unit 122. The terminal device 102 is a terminal through which the user of the information processing system 100 inputs instructions to the information processing device 101.

The input unit 122 is composed of input devices such as a keyboard and a mouse. The input unit 112 receives data input by the user using those input devices, and supplies the input data to the processing unit 120. For example, the input unit 122 receives data for requesting a start of the (1) operation status ascertaining processing, the (2) user comprehension degree ascertaining processing, or the (3) effect inhibition factor/countermeasure specification processing described above, and supplies the data to the processing unit 120.

The processing unit 120 includes a control unit that performs overall control of the terminal device 102, a memory unit that stores various programs and data, and a communication unit that communicates with the information processing device 101. For example, the processing unit 120 generates a control signal for requesting the information processing device 101 to start the (1) operation status ascertaining processing, the (2) user comprehension degree ascertaining processing, or the (3) effect inhibition factor/countermeasure specification processing described above, based on the data supplied from the input unit 122. Then, the processing unit 120 supplies the control signal to the information processing device 101 via the communication unit.

The output unit 121 is composed of an output device such as a liquid crystal display (LCD). The user can ascertain content of data supplied from the information processing device 101 by viewing images or character strings displayed on the LCD. The LCD in this case is a display element of a dot matrix type, and displays arbitrary characters, symbols, numerals, and figures.

As described above, the terminal device 102 can be configured by using a generally available computer or the like.

Next, a description will be given of processing for specifying an effect inhibition factor of the support system 11, which is executed in the information processing system 100 according to this embodiment. The processing for specifying an effect inhibition factor will be described by dividing the processing into sections of: the (1) operation status ascertaining processing, the (2) user comprehension degree ascertaining processing, and the (3) effect inhibition factor/countermeasure specification processing, described above.

((1) Operation Status Ascertaining Processing)

In order to ascertain the operation status, it is necessary to check whether the user is carrying out necessary operations on the support system 11. In particular, it is necessary to check the frequency at which the manager ascertains the progression status of the project, the frequency at which the person in charge of the task registers the progression status of the task, and the like. Thus, in the present invention, the operation status of the user with respect to the support system 11 is ascertained by using the operation logs.

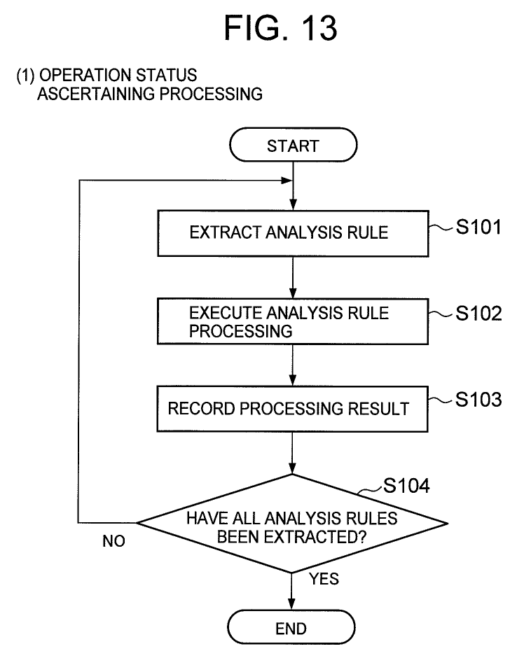

By referring to the flowchart of FIG. 13, a description will be given of the (1) operation status ascertaining processing for ascertaining the operation status by using the operation logs, as described above.

The control unit 114 starts the (1) operation status ascertaining processing when an interruption input due to the supply of the control signal for requesting the start of the processing is made through the input unit 112. In addition, the control unit 114 also starts the (1) operation status ascertaining processing when the control signal that requests the start of the processing is supplied from any of the terminal devices 102 via the network 103 and the communication unit 113.

The control unit 114 loads to the short-term memory unit 115 the operation status ascertaining program 202 stored in the long-term memory unit 116. The control unit 114 executes the following processing according to the operation status ascertaining program 202.

First, the control unit 114 accesses the operation log analysis rule database 402 shown in FIG. 5, and extracts the analysis rule 601B stored in the operation log analysis rule table 601 (S101). Specifically, the control unit 114 loads, to the short-term memory unit 115, data of the operation status analysis rule name 601A and the analysis rule 601B of one entry stored in the operation log analysis rule table 601.

Subsequently, the control unit 114 executes the processing according to the description in the analysis rule 601B that has been loaded to the short-term memory unit 115 (S102). It is assumed that the analysis rule 601B contains a description on processing for obtaining the “frequency at which the project manager ascertains the progression status of the project” (which will be referred to as processing A), for example. Further, it is assumed that the analysis rule 601B contains a description on processing for obtaining the “frequency at which the person in charge of the task of the project registers the progression information of the task” (which will be referred to as processing B), for example. Further, it is assumed that the analysis rule 601B contains a description on processing for obtaining a “proportion of the project task to which a person in charge is not yet assigned” (which will be referred to as processing C), for example.

When the processing A is described in the analysis rule 601B, the control unit 114 first accesses the operation log database 401 and refers to the operation log table 501 stored in the operation log database 401 (an example of the operation log table 501 is shown in FIG. 6). Next, the control unit 114 loads to the short-term memory unit 115 data whose date/time information 501B belongs to a predetermined period (e.g., one month from 2007/10/100:00:00 to 2007/10/31 24:00:00). Here, the control unit 114 retrieves data whose identification information 501A for the user is “manager” and whose data value for the operation content 501C is “project progression display”, from the pieces of data loaded to the short-term memory unit 115. At this time, the control unit 114 counts a data amount x1 of data that corresponds to the retrieval conditions. The control unit 114 stores the counted data amount x1 in a predetermined storage area of the short-term memory unit 115. Accordingly, the control unit 114 obtains the frequency at which the project manager ascertains the project progression status (data amount x1 (times/month)).

Further, when the processing B is described in the analysis rule 601B, the control unit 114 first accesses the operation log database 401 and refers to the operation log table 501 stored in the operation log database 401. Next, the control unit 114 loads to the short-term memory unit 115 data whose date/time information 501B belongs to a predetermined period (e.g., one month from 2007/10/1 00:00:00 to 2007/10/31 24:00:00). Here, the control unit 114 retrieves data whose identification information 501A for the user is “user B”, whose data value for the operation content 501C is “task progression registration”, and whose data value for the parameter 501D is “project A”, from the pieces of data loaded to the short-term memory unit 115. At this time, the control unit 114 counts a data amount x2 of data that corresponds to the retrieval conditions. The control unit 114 stores the counted data amount x2 in a predetermined storage area of the short-term memory unit 115. Accordingly, the control unit 114 obtains the frequency at which the person in charge of the task of the project registers the progression information for the task (data amount x2 (times/month)).

Further, when the processing C is described in the analysis rule 601B, the control unit 114 first accesses the operation log database 401 and refers to the operation log table 501 stored in the operation log database 401. Next, the control unit 114 loads to the short-term memory unit 115 data whose date/time information 501B belongs to a predetermined period (e.g., one month from 2007/10/1 00:00:00 to 2007/10/31 24:00:00). The control unit 114 retrieves data whose data value for the operation content 501C is “task registration”, from the pieces of data loaded to the short-term memory unit 115. At this time, the control unit 114 counts a data amount x3 of data that corresponds to the retrieval condition. The control unit 114 stores the counted data amount x3 in a predetermined storage area of the short-term memory unit 115. In addition, the control unit 114 retrieves data whose data value for the parameter 501D is “person in charge undetermined”, from the pieces of data loaded to the short-term memory unit 115. The control unit 114 counts a data amount y3 of data that corresponds to the retrieval condition. The control unit 114 stores the counted data amount y3 in a predetermined storage area of the short-term memory unit 115. Here, the control unit 114 obtains the proportion of the project task to which a person in charge is not yet assigned ((y3/x3)×100(%)), based on the values stored in the short-term memory unit 115.

Next, the control unit 114 stores the values, obtained in Step S102 described above, in the long-term memory unit 116 (S103). Specifically, the control unit 114 first accesses the operation status ascertaining result database 403. Then, the control unit 114 stores the operation status analysis rule name 601A loaded to the short-term memory unit 115 and the resultant values obtained in Step S102 in the operation status ascertaining result table 701 as shown in FIG. 8 in association with one another.

Subsequently, the control unit 114 judges whether processing of all the analysis rules 601B stored in the operation log analysis rule table 601 has been completed (S104). Specifically, the control unit 114 makes the judgment based on the presence or absence of a symbol indicating an end of the operation log analysis rule table 601.

Here, when it is judged that the processing of all the analysis rules 601B has not been completed (S104; No), the control unit 114 shifts the processing back to Step S101 and extracts the next analysis rule 601B.

On the other hand, when it is judged in Step S104 that the processing of all the analysis rules 601B has been completed (S104; Yes), the control unit 114 ends the (1) operation status ascertaining processing.

The information processing system 100 that executes the (1) operation status ascertaining processing described above executes the processing based on a plurality of analysis rules 601B with respect to the operation log recorded in the operation log table 501. Accordingly, the user can diversely ascertain the operation status of the already-existing support system 11 that has been incorporated in the information processing system 100.

((2) User Comprehension Degree Ascertaining Processing)

In order to ascertain the user comprehension degree with respect to the operation method of the support system 11, it is only necessary to check whether the user has sufficient knowledge necessary for appropriately operating the support system 11. In particular, it is only necessary to check whether the user has knowledge of the frequency at which the manager ascertains the progression status of the project, an item registered by the person in charge of the task when the task allocated to the person in charge of the task is completed, and the like. Thus, in the present invention, the user comprehension degree with respect to the operation method is ascertained by using questions about knowledge necessary for appropriately operating the support system 11.

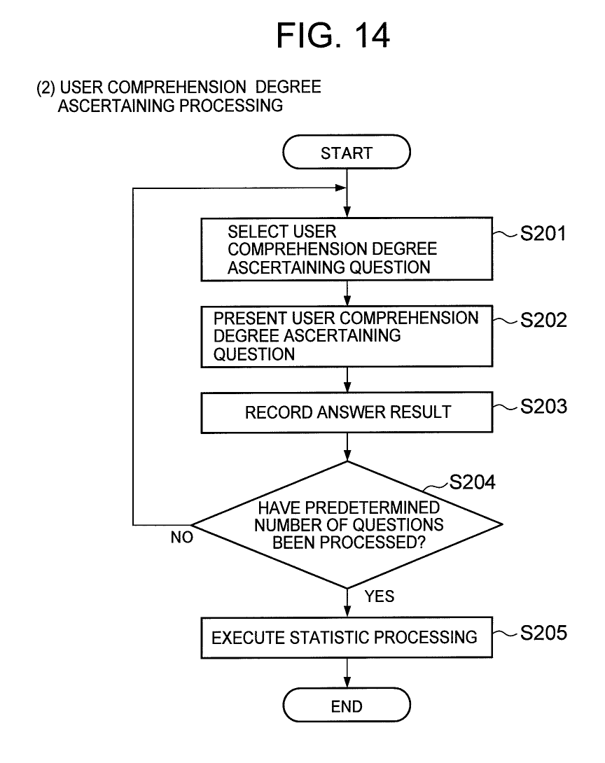

By referring to the flowchart of FIG. 14, a description will be given of the (2) user comprehension degree ascertaining processing for ascertaining the user comprehension degree with respect to the operation method, by using questions.

The control unit 114 starts the (2) user comprehension degree ascertaining processing when an interruption input due to the supply of the control signal for requesting the start of the processing is made from the input unit 112. In addition, the control unit 114 also starts the (2) user comprehension degree ascertaining processing when the control signal that requests the start of the processing is supplied from any of the terminal devices 102 via the network 103 and the communication unit 113.

The control unit 114 loads to the short-term memory unit 115 the user comprehension degree ascertaining program 203 stored in the long-term memory unit 116. The control unit 114 executes the following processing according to the user comprehension degree ascertaining program 203.

The control unit 114 first accesses the user comprehension degree ascertaining question database 404 shown in FIG. 5. Then, the control unit 114 selects any of the question names from the user comprehension degree ascertaining question name 810A stored in the user comprehension degree ascertaining question table 801 shown in FIG. 9 (S201). Note that when the user who has requested the start of the (2) user comprehension degree ascertaining processing is the project manager, the control unit 114 selects the question name from among the question names for a manager. Further, in the case of a person in charge of a task, the question name is selected from among the question names for a person in charge of a task.

Specifically, the control unit 114 first loads to the short-term memory unit 115 the user comprehension degree ascertaining question name 801A stored in the user comprehension degree ascertaining question table 801. At this time, the control unit 114 loads all the user comprehension degree ascertaining question names 801A containing the information corresponding to the identification information 501A of the user that has requested starting of the (2) user comprehension degree ascertaining processing. The control unit 114 randomly extracts one user comprehension degree ascertaining question name 801 A from all the user comprehension degree ascertaining question names 801A loaded to the short-term memory unit 115. The control unit 114 temporarily stores the data value of the extracted user comprehension degree ascertaining question name 801A in the short-term memory unit 115.

Next, the control unit 114 presents to the user the question 801B and the option 801C that correspond to the user comprehension degree ascertaining question name 801A selected in Step S201 (S202).

Specifically, the control unit 114 first accesses the user comprehension degree ascertaining question database 404 shown in FIG. 5. Then, the control unit 114 retrieves data that matches the user comprehension degree ascertaining question name 801A that has been selected in Step S202, from among the data of the user comprehension degree ascertaining question names 801A stored in the user comprehension degree ascertaining question table 801 shown in FIG. 9. After that, the control unit 114 loads to the short-term memory unit 115 data of the question 801B and the option 801C that correspond to the data corresponding to the retrieval condition.

The control unit 114 supplies the data of the question 801B and the option 801C that has been loaded to the short-term memory unit 115 to the terminal device 102 that has supplied the control signal requesting starting of the (2) user comprehension degree ascertaining processing.

At this time, the processing unit 120 of the terminal device 102 receives the data of the question 801B and the option 801C, and displays the question 801B and the option 801C on the output unit 121. Accordingly, the user can read the question 801B displayed on the output unit 121 and select a desired answer from the displayed options 801C.

The processing unit 120 waits until data containing the answer selected by the user is supplied from the input unit 122. When the data supplied from the input unit 122 is received, the processing unit 120 supplies the data to the control unit 114 of the information processing device 101.

The control unit 114 receives the data supplied from the processing unit 120 and temporarily stores the data in the short-term memory unit 115.

Note that when the (2) user comprehension degree ascertaining processing is started in response to an instruction from the input unit 112 of the device (information processing device) 101, the processing operation of the information processing system 100 in Step S202 differs from that described above.

Specifically, the control unit 114 supplies the data of the question 801B and the option 801C that has been loaded to the short-term memory unit 115 to the output unit 111, and causes the output unit 111 to display the data. Accordingly, the user of the device (information processing device) 101 can read the question 801B displayed on the output unit 111 and select a desired answer from the displayed options 801C.

At this time, the control unit 114 waits until the data containing the answer selected by the user is supplied from the input unit 112.

The control unit 114 receives the data supplied from the input unit 112 and temporarily stores the data in the short-term memory unit 115.

Next, the control unit 114 stores the data containing the answer of the user, which is temporarily stored in the short-term memory unit 115 in Step S202, in the user answer result database 405 so that the data can be reused (S203).

Specifically, the control unit 114 first accesses the user comprehension degree ascertaining question database 404 shown in FIG. 5. Then, the control unit 114 loads to the short-term memory unit 115 data of the correct answer 801D corresponding to the question 801B that has been presented to the user in Step S202, among the data stored in the user comprehension degree ascertaining question table 801.

Subsequently, the control unit 114 judges whether the data value of the correct answer 801D loaded to the short-term memory unit 115 and the data value including the answer of the user stored in the short-term memory unit 115 in Step S202 match each other.

Here, when it is judged that the data values match each other, the control unit 114 first accesses the user answer result database 405 shown in FIG. 5. Then, the control unit 114 stores the user comprehension degree ascertaining question name 801A selected by the user in Step S201, the identification information of the user, and the data value indicating the “correct answer”, in the user answer result table 901 in association with one another, as shown in FIG. 10A.

On the other hand, when it is judged that the data values do not match each other, the control unit 114 first accesses the user answer result database 405 shown in FIG. 5. Then, the control unit 114 stores the user comprehension degree ascertaining question name 801A selected by the user in Step S201, the identification information of the user, and the data value indicating the “incorrect answer”, in the user answer result table 901 in association with one another, as shown in FIG. 10A.

In addition, the control unit 114 executes the processing of presenting the correct answer to the question 801A and the explanation thereof, to the user.

Specifically, the control unit 114 loads to the short-term memory unit 115 the data of the correct answer 801D and the explanation 801E corresponding to the question 801B that has been presented to the user in Step S202, among the data stored in the user comprehension degree ascertaining question table 801. Subsequently, the control unit 114 supplies the data of the correct answer 801D and the explanation 801E that has been loaded to the short-term memory unit 115 to the terminal device 102 that has supplied the control signal requesting the start of the (2) user comprehension degree ascertaining processing.

At this time, the processing unit 120 of the terminal device 102 receives the data of the correct answer 801D and the explanation 801E, and displays the correct answer 801D and the explanation 801E on the output unit 121. Accordingly, the user can read the correct answer 801D and the explanation 801E displayed on the output unit 121, to thereby improve the comprehension degree with respect to the operation method.

Note that when the (2) user comprehension degree ascertaining processing is started in response to an instruction from the input unit 112 of the device (information processing device) 101, the processing operation of presenting the correct answer 801D and the explanation 801E to the user in this case differs from that described above.

Specifically, the control unit 114 supplies the data of the correct answer 801D and the explanation 801E that has been loaded to the short-term memory unit 115, to the output unit 111, and causes the output unit 111 to display the correct answer 801D and the explanation 801E. Accordingly, the user of the device (information processing device) 101 can read the correct answer 801D and the explanation 801E displayed on the output unit 111, to thereby improve the comprehension degree with respect to the operation method.

Next, the control unit 114 judges whether answers to the predetermined number of questions (e.g., 100 questions) have been acquired (S204).

Specifically, the control unit 114 counts the data amount of the correct/incorrect indicator 901C stored in the user answer result table 901. When the counted data amount of the correct/incorrect indicator 901C matches the predetermined number of questions, the control unit 114 judges that the acquisition has been completed. When the data amount is smaller than the predetermined number of questions, the control unit 114 judges that the acquisition is not yet completed.

Here, when it is judged that the answers to the predetermined number of questions have not been acquired (S204; No), the control unit 114 shifts the processing back to Step S201 and selects the next question.

On the other hand, when it is judged in Step S204 that the answers to the predetermined number of questions have been acquired (S204; Yes), the control unit 114 performs statistic processing on the result of the answers acquired in Step S203 (S205).

Specifically, the control unit 114 first accesses the user answer result database 405 shown in FIG. 5. Then, the control unit 114 loads to the short-term memory unit 115 all pieces of data of the correct/incorrect indicator 901C corresponding to the data having the same user comprehension degree ascertaining question name 901A (e.g., project progression ascertaining frequency), among the data stored in the user answer result table 901.

The control unit 114 counts a loaded data amount x4 and stores the counted data amount x4 in a predetermined area of the short-term memory unit 115. In addition, the control unit 114 retrieves the data whose data value for the correct/incorrect indicator 901C is “correct” among the data loaded to the short-term memory unit 115. At this time, the control unit 114 counts a data amount y4 of the data that corresponds to the retrieval condition. The control unit 114 stores the counted data amount y4 in the predetermined area of the short-term memory unit 115. Here, the control unit 114 obtains a correct answer rate (data amount y4/data amount x4) for each user comprehension degree ascertaining question name 901A based on the values stored in the short-term memory unit 115. The control unit 114 temporarily stores the obtained value of the correct answer rate in the short-term memory unit 115.

Next, the control unit 114 accesses the user comprehension degree ascertaining result database 406 shown in FIG. 5. Then, the control unit 114 stores the user comprehension degree ascertaining question name 801A selected in Step S201 and the value of the correct answer rate temporarily stored in the short-term memory unit 115, in the user comprehension degree ascertaining result table 911 in association with each other, as shown in FIG. 10B.

After that, the control unit 114 ends the (2) user comprehension degree ascertaining processing.

The evaluation system 10 that executes the (2) user comprehension degree ascertaining processing described above presents questions regarding the operation method of the already-existing support system 11 incorporated in the information processing system 100. Further, the evaluation system 10 performs statistic processing on the result of the answers of the user with respect to the presented questions. Accordingly, it is possible to ascertain the extent to which the user understands the operation method of the already-existing support system 11 incorporated in the information processing system 100.

((3) Effect Inhibition Factor/Countermeasure Specification Processing)

It has already been described that it is only necessary to ascertain the operation status of the support system 11 and the user comprehension degree with respect to the operation method of the support system 11 in order to specify an effect inhibition factor when the introduction effect of the support system 11 cannot be acquired. Thus, in the present invention, the effect inhibition factor is specified based on the operation status data 701B produced in the (1) operation status ascertaining processing and the correct answer rate 911B produced in the (2) user comprehension degree ascertaining processing.

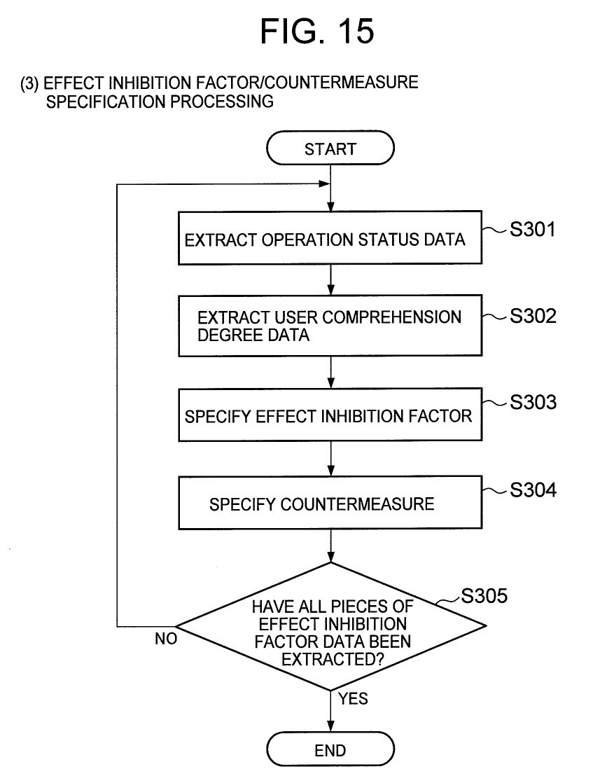

Next, by referring to the flowchart of FIG. 15, a description will be given of specific processes of the (3) effect inhibition factor/countermeasure specification processing executed by the evaluation system 10.

The control unit 114 starts the (3) effect inhibition factor/countermeasure specification processing when an interruption input due to the supply of the control signal for requesting the start of the processing is made from the input unit 112. In addition, the control unit 114 also starts the (3) effect inhibition factor/countermeasure specification processing when the control signal, which requests the start of the processing, is supplied from any of the terminal devices 102 via the network 103 and the communication unit 113.

The control unit 114 loads to the short-term memory unit 115 the effect inhibition factor/countermeasure specification program 204 stored in the long-term memory unit 116. The control unit 114 executes the following processing according to the effect inhibition factor/countermeasure specification program 204.

The control unit 114 first accesses the operation status ascertaining result database 403 shown in FIG. 5, and extracts the operation status data 701B stored in the operation status ascertaining result table 701 (S301). Specifically, the control unit 114 loads to the short-term memory unit 115 data of the operation status analysis rule name 701A and the operation status data 701B of one entry stored in the operation status ascertaining result table 701.

Next, the control unit 114 accesses the user comprehension degree ascertaining result database 406 shown in FIG. 5, and extracts the data value of the correct answer rate 911B stored in the user comprehension degree ascertaining result table 911 (S302). Specifically, the control unit 114 loads to the short-term memory unit 115 the data of the user comprehension degree ascertaining question name 911A and the correct answer rate 911B of one entry stored in the user comprehension degree ascertaining result table 911.

Further, the control unit 114 specifies the effect inhibition factor in the case where the introduction effect of the support system 11 in the information processing system 100 cannot be acquired, based on the data loaded in Step S301 and the data loaded in Step S302 (S303). Along with the specification of the effect inhibition factor, the control unit 114 specifies a countermeasure that corresponds to the effect inhibition factor specified in Step S303 (S304).

Specifically, the control unit 114 first accesses the effect inhibition factor/countermeasure database 407 shown in FIG. 5. Then, the control unit 114 retrieves, from the data stored in the effect inhibition factor/countermeasure table 1001, data having data values that match all the data values of the operation status analysis rule name 701A, the operation status data 701B, the user comprehension degree ascertaining question name 911A, and the correct answer rate 911B that have been loaded to the short-term memory unit 115 in the above-mentioned steps. The control unit 114 loads to the short-term memory unit 115 the data of the effect inhibition factor 1001E and the countermeasure 1001F stored in association with the data corresponding to the retrieval conditions.

The control unit 114 supplies the data of the effect inhibition factor 1001E and the data of the countermeasure 1001F that have been loaded to the short-term memory unit 115, to the terminal device 102 that has supplied the control signal for requesting the start of the (3) effect inhibition factor/countermeasure specification processing.

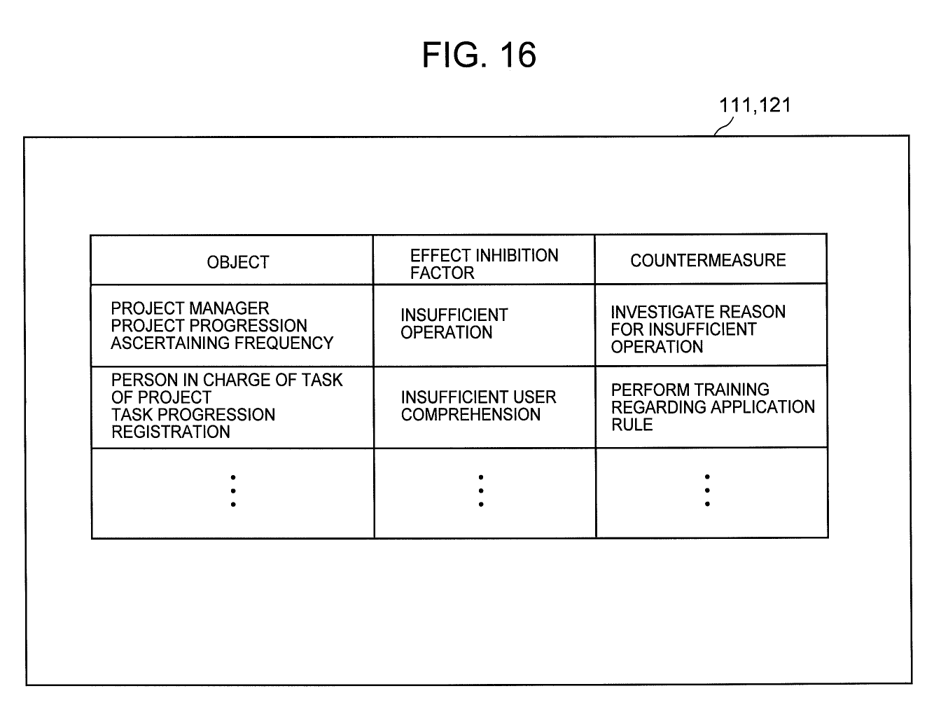

At this time, the processing unit 120 of the terminal device 102 receives the data of the effect inhibition factor 1001E and the countermeasure 1001F, and displays the effect inhibition factor 1001E and the countermeasure 1001F on the output unit 121 as shown in FIG. 16, for example. Accordingly, the user can ascertain the effect inhibition factor and the countermeasure in the case where the introduction effect of the support system 11 incorporated in the information processing system 100 cannot be acquired.

Note that the present invention is not limited to the above embodiment and various modifications or applications can be made.

For example, in the above embodiment, the (1) operation status ascertaining processing is started upon receiving an interruption input from the input unit 112. However, the present invention is not limited thereto and the timing at which the (1) operation status ascertaining processing is started may be arbitrary. For example, the (1) operation status ascertaining processing may be started periodically.

Further, in the above embodiment, the (2) user comprehension degree ascertaining processing is started upon receiving an interruption input from the input unit 112. However, the present invention is not limited thereto and the timing at which the (2) user comprehension degree ascertaining processing is started may be arbitrary. For example, the (2) user comprehension degree ascertaining processing may be started periodically.

Further, in the above embodiment, the (3) effect inhibition factor/countermeasure specification processing is started upon receiving an interruption input from the input unit 112. However, the present invention is not limited thereto and the timing at which the (3) effect inhibition factor/countermeasure specification processing is started may be arbitrary. For example, the (3) effect inhibition factor/countermeasure specification processing may be started periodically.

Further, in the above embodiment, the factor that inhibits the introduction effect of the support system 11 is specified by the control unit 114 of the information processing device 101 executing the various programs stored in the long-term memory unit 116. However, the present invention is not limited thereto. If the effect inhibition factor can be specified by the information processing system 100 as a whole, the device that stores the various programs or the device that executes the various programs may be an arbitrary device.

In addition, in the above embodiment, the databases 401 to 407 are stored in the information processing device 101. However, the present invention is not limited thereto and the databases may be stored in an arbitrary device. For example, the databases 401 to 407 may be stored in a database server connected to the network 103, and a request for database processing may be made to the database server. Further, the databases 401 to 407 may respectively be stored in different devices.

Further, in the above embodiment, in the case where the control unit 114 executes the processing A of the analysis rule 601B (Step S102 of FIG. 13), the statistic processing may be carried out for each project. Accordingly, the “frequency at which the project manager ascertains the progression status of the project” can be obtained for each project.

In addition, in the above embodiment, the control unit 114 randomly selects the user comprehension degree ascertaining question name 801A in Step S201. However, the present invention is not limited thereto and the user comprehension degree ascertaining question name 801A may be selected according to other predetermined rules.

Further, in the above embodiment, the control unit 114 selects the user comprehension degree ascertaining question name 801A (S201) However, the present invention is not limited thereto and the user may select the user comprehension degree ascertaining question name 801A.

Specifically, all the user comprehension degree ascertaining question names 801A loaded to the short-term memory unit 115 are supplied to the terminal device 102 that has supplied the control signal requesting the start of the (2) user comprehension degree ascertaining processing.

At this time, the processing unit 120 of the terminal device 102 receives the user comprehension degree ascertaining question names 801A, and displays all the user comprehension degree ascertaining question names 801A on the output unit 121. Accordingly, the user can select a desired question name from the user comprehension degree ascertaining question names 801A displayed on the output unit 121.

The processing unit 120 waits until the data containing the user comprehension degree ascertaining question name 801A selected by the user is supplied from the input unit 122. Upon reception of the data supplied from the input unit 122, the processing unit 120 supplies the data to the control unit 114 of the information processing device 101.

The control unit 114 receives the data supplied from the processing unit 120 and temporarily stores the data in the short-term memory unit 115.

Note that when the (2) user comprehension degree ascertaining processing is started in response to an instruction from the input unit 112 of the device (information processing device) 101, the processing operation of the information processing system 100 in Step S201 differs from that described above.

Specifically, the control unit 114 supplies the user comprehension degree ascertaining question names 801A loaded to the short-term memory unit 115 to the output unit 111, and causes the output unit 111 to display the user comprehension degree ascertaining question names 801A. Accordingly, the user of the device (information processing device) 101 can select a desired question name from the user comprehension degree ascertaining question names 801A displayed on the output unit 111.

At this time, the control unit 114 waits until the data containing the user comprehension degree ascertaining question name 801A selected by the user is supplied from the input unit 112.

The control unit 114 receives the data supplied from the input unit 112 and temporarily stores the data in the short-term memory unit 115.

Further, in Step S205, the control unit 114 obtains the correct answer rate for each user comprehension degree ascertaining question name 901A. However, the present invention is not limited thereto and the correct answer rate may be obtained for each user attribute (manager or person in charge of a task) or for each item of identification information 501A for the user. In the case of obtaining the correct answer rate for each user at tribute, the control unit 114 loads to the short-term memory unit 115 all pieces of data of the correct/incorrect indicator 901C corresponding to the data of the user comprehension degree ascertaining question names 901A having the same attribute (manager or person in charge of a task), among the data stored in the user answer result table 901. The control unit 114 counts a loaded data amount x5 and stores the counted data amount x5 in the predetermined area of the short-term memory unit 115. Further, the control unit 114 retrieves data whose data value of the correct/incorrect indicator 901C is “correct” from among the data loaded to the short-term memory unit 115. At this time, the control unit 114 counts a data amount y5 of the data that corresponds to the retrieval condition. The control unit 114 stores the counted data amount y5 in the predetermined area of the short-term memory unit 115. Here, the control unit 114 obtains the correct answer rate (data amount y5/data amount x5) for each user attribute based on the values stored in the short-term memory unit 115. The control unit 114 temporarily stores the obtained value of the correct answer rate in the short-term memory unit 115.

Further, the statistic processing of Step S205 is not limited to the processing of obtaining the correct answer rate. For example, the statistic processing may arbitrarily involve obtaining a mean value of the number of correct answers, obtaining a standard deviation of the number of correct answers, and the like.

Further, in the above embodiment, the support system 11 is a system that prevents delay of a project (task), and the evaluation system 10 is a system that evaluates the support system 11. However, the present invention is not limited thereto and the support system 11 may arbitrarily be a system that supports management of a document, for example.

Further, in the above embodiment, the programs executed by the control unit 114 are stored in advance in the long-term memory unit 116. However, the present invention is not limited thereto and a provision method for the programs that allow the above-mentioned processing to be executed is arbitrary. For example, the programs can be provided via a communication medium such as the Internet, or the programs may be stored in a recording medium such as a memory card to be distributed.

What is claimed is:

1. An evaluation system which receives an instruction from at least one user and carries out an evaluation regarding a support system that supports a task of the at least one user by executing processing according to the instruction, the system comprising:
an analysis table in which is recorded, for each of operation evaluation items, a rule for calculating an operation evaluation index based on the instruction from the at least one user;
a question table in which is recorded, for each of comprehension degree evaluation items, a question group which is used for calculating a comprehension degree evaluation index based on a comprehension degree of the at least one user regarding the support system;
an evaluation table in which is recorded, for each of support system evaluation items, an evaluation regarding the support system in association with the operation evaluation index and the comprehension degree evaluation index;
an instruction history recording unit which acquires and records the instruction from the at least one user received by the support system;
an operation evaluation index calculation unit which calculates the operation evaluation index for each of the operation evaluation items based on the instruction recorded by the instruction history recording unit and the analysis table;
a presenting unit which presents a question group recorded in the question table;
a comprehension degree evaluation index calculation unit which calculates the comprehension degree evaluation index for each of the comprehension degree evaluation items after receiving answers to the question group, presented by the presenting unit, from the at least one user; and
an evaluation unit which carries out the evaluation regarding the support system for each of the support system evaluation items based on the operation evaluation index calculated by the operation evaluation index calculation unit, on the comprehension degree evaluation index calculated by the comprehension degree evaluation index calculation unit, and on the evaluation table, and outputs the evaluation result.

2. An evaluation system according to claim 1, wherein the evaluation regarding the support system, which is recorded in the evaluation table, includes a first evaluation indicating that introduction of the support system is inappropriate, a second evaluation indicating that user comprehension with respect to an operation method of the support system is insufficient, and a third evaluation indicating that an operation of the support system is insufficient.

3. An evaluation system according to claim 2, wherein in the evaluation table:
the first evaluation is associated with a case where the operation evaluation index satisfies a predetermined criterion;
the second evaluation is associated with a case where the operation evaluation index fails to satisfy the predetermined criterion and the comprehension degree evaluation index satisfies a predetermined criterion; and
the third evaluation is associated with a case where both the operation evaluation index and the comprehension degree evaluation index fail to satisfy the predetermined criteria.

4. An evaluation system according to claim 1, wherein:
the evaluation table further records a countermeasure in response to the evaluation regarding the support system; and
the evaluation unit adds the countermeasure recorded in the evaluation table to the evaluation result and outputs the evaluation result.

5. An evaluation system according to claim 1, wherein:
the question groups are classified according to an attribute of the at least one user;
the presenting unit presents, among the question groups, a question group corresponding to the attribute; and
the comprehension degree evaluation index calculation unit calculates the comprehension degree evaluation index for each of the comprehension degree evaluation items after receiving answers to the question group presented by the presenting unit, from the at least one user.

6. An evaluation system according to claim 1, wherein:
the support system comprises a system which notifies the at least one user of a task progression status; and
the operation evaluation index is based on an instruction that causes the support system to notify the at least one user of the task progression status.

7. An evaluation method in an evaluation system which receives an instruction from at least one user and carries out an evaluation regarding a support system that supports a task of the at least one user by executing processing according to the instruction, the evaluation method comprising:
an instruction history recording step which acquires and records the instruction from the at least one user received by the support system;
an operation evaluation index calculation step which calculates, for each of operation evaluation items, an operation evaluation index from an operation evaluation index based on the instruction recorded in the instruction history recording step;
a comprehension degree evaluation index calculation step which calculates a comprehension degree evaluation index based on a comprehension degree of the at least one user regarding the support system; and
an evaluation step which carries out the evaluation regarding the support system for each of support system evaluation items based on the operation evaluation index calculated in the operation evaluation index calculation step and the comprehension degree evaluation index calculated in the comprehension degree evaluation index calculation step, and outputs the evaluation result.

8. A program product which causes a computer of an evaluation system, which receives an instruction from at least one user and carries out an evaluation regarding a support system that supports a task of the at least one user by executing processing according to the instruction, to execute:
an instruction history recording procedure which acquires and records the instruction from the at least one user received by the support system;
an operation evaluation index calculation procedure which calculates, for each of operation evaluation items, an operation evaluation index from an operation evaluation index based on the instruction recorded in the instruction history recording procedure;
a comprehension degree evaluation index calculation procedure which calculates a comprehension degree evaluation index based on a comprehension degree of the at least one user regarding the support system; and
an evaluation procedure which carries out the evaluation regarding the support system for each of support system evaluation items based on the operation evaluation index calculated in the operation evaluation index calculation procedure and the comprehension degree evaluation index calculated in the comprehension degree evaluation index calculation procedure, and outputs the evaluation result.
